(19) United States
(12) Patent Application Publication
(10) Pub. No.: US 2009/0303706 A1
(43) Pub. Date: Dec. 10, 2009

(54) WAVE LENGTH LIGHT OPTIMIZER FOR HUMAN DRIVEN BIOLOGICAL PROCESSES

(76) Inventor: Lucia Atehortua, Medellin (CO)

Correspondence Address: JOHN J. MARTINEZ MD. JD., 10 PALMER AVENUE, CROTON ON HUDSON, NY, 10520, US

(21) Appl. No.: 12/135,340

(22) Filed: Jun. 9, 2008

(51) Int. Cl. F21V 7/00

(52) U.S. Cl. 362/231; 362/247

(57) ABSTRACT

The present invention provides a system for optimized illumination of biological processes, wherein said system comprises a LED (Light Emitting Diode) or LEDs and a tridimensional enclosure or tridimensional enclosures, which allows ideal distribution of lighting with specific light wavelengths, low power energy consumption and low heat generation. The system of the present invention permits using specific light wavelengths in alternating or cycling ways, as well as easy-to-set light-dark cycles.

### BACKGROUND OF THE INVENTION

1. Field of the Present Invention

The field of the present invention relates to a system to optimize illumination with LEDs (Light Emitting Diodes) that emit specific light wavelengths, wherein said illumination is used on light affected biological processes.

2. Description of Prior Art

Biological processes that are affected by illumination with specific light wavelengths are well documented in the literature. However, there are limitations regarding adequate illumination distribution conditions required to achieve desired efficiencies of specific biological processes.

By way of example, U.S. patent application Ser. No. 11/746,389 by Bayless describes an apparatus with a complex light distribution system to illuminate algae that detoxify CO₂ to O₂ in a photosynthetic process or for algae that may be involved in biodiesel refining. Bayless refers to adequate amounts of collected solar white light and dark zones without mentioning at all the effect of light with specific wavelengths, e.g., red light.

LED emitted red light (680 nm wavelength) is known to increase 5-fold the production of oxygen of algal cultures (see Lee, C. G. and Palsson B. O., High Density Algal Photobioreactors Using Light Emitting Diodes, Biotechnology and Bioengineering. 44:1161-1167 (1994)). Lee and Palsson mention the minimization by LEDs of heat generation, but conclude about the need to improve light distribution.

Another biological process affected by light is greenhouse plant growth. Jagers mentions the advantage of LEDs for horticultural processes, specifically that LEDs increase energy efficiency by 30% (see Jagers op Akkerhuis, F., LED lighting Systems Will Be More Efficient, Fruit and Veg. Tech., 7:5 pages 6-7 (2207). However, Jagers concludes with questions with respect to the proper illumination conditions.

A further example of the potential advantage of illumination using LEDs is described by Tamulaitis. Tamulaitis discloses how growing lettuce and radish could be improved by illuminating with four wavelength light LEDs (see Tamulaitis, G. et al., High Power Light-Emitting Diode Based Facility for Plant Cultivation, J. Phys. D: Appl. Phys. 38:3182-3187 (2005)). However Tamulaitis concludes that further optimization is required.

Additional examples are U.S. Pat. No. 4,060,933 to Kadkade that describes explants tissue culture under illumination with a specific light wavelength, and U.S. Pat. No. 6,921,182 to Anderson that discloses illuminating with complex array of LEDS to enhance plant growth.

Although there is ample evidence about the need of adequate illumination systems for biological processes, e.g., plant growth, algae CO₂ detoxification, alga refining of biodiesels, tissue culture, etc, there is no description in the prior art of an illumination system which allows optimal distributed lighting with specific light wavelengths, low power energy consumption and low heat generation.

### SUMMARY OF THE INVENTION

The present invention provides a system for optimized illumination of biological processes, wherein said system comprises a LED (Light Emitting Diode) or LEDs and a tridimensional enclosure or tridimensional enclosures, which allows ideal distribution of lighting with specific light wavelengths, low power energy consumption and low heat generation. The system of the present invention permits using specific light wavelengths in alternating or cycling ways, as well as easy-to-set light-dark cycles. In previous pending unpublished U.S. patent applications Ser. No. 11/635,986 and 12/135,175, which are incorporated herein in their entirety by reference, the first inventor of the present application describes specific applications methods that use the system.

More specifically, the present invention provides a tridimensional closed system that houses within biological processes, wherein said system comprises:
A. A tridimensional enclosure with internal surfaces, wherein all tridimensional enclosure internal surfaces have all the characteristics of a mirror, and wherein said tridimensional enclosure houses all the elements of a ongoing biological process affected by lighting;
B. At least one source of light that illuminates the tridimensional enclosure internal space, wherein the tridimensional enclosure is sealed in order not to allow entry of light from outside of the tridimensional enclosure.

In a preferred aspect of the system of the present invention, all tridimensional enclosure internal surfaces are mirrors.

In another preferred aspect of the system of the present invention, the source of light is a Light Emitting Diode (LED), wherein the LED emits a specific wavelength light.

In one more aspect of the system of the present invention, the tridimensional enclosure has a mechanism to regulate temperature.

In one further aspect of the system of the present invention, the tridimensional enclosure has a mechanism to monitor temperature.

In another aspect of the system of the present invention, the tridimensional enclosure has mechanisms to regulate and monitor humidity.

In an additional aspect of the system of the present invention, the system has a mechanism of agitation.

In one more aspect of the system of the present invention, the tridimensional enclosure is constituted by a single compartment.

In another aspect of the system of the present invention, the tridimensional enclosure is constituted by more than one compartment, and wherein each compartment has at least one source of light that illuminates inside each compartment.

In a further aspect of the system of the present invention, the tridimensional enclosure is constituted by more than one compartment, wherein each compartment has at least one source of light that illuminates inside each compartment, wherein the source of light is a LED, and wherein the source of light of each compartment emits a specific light wavelength.

Objectives and additional advantages of the present invention will become more evident in the description of the figures, the detailed description of the invention and the claims.

### BRIEF DESCRIPTION OF THE DRAWINGS

FIG. 1. is an illustrative view of an embodiment of the tridimensional closed system of the present invention.

FIG. 2. is another view of an embodiment of the tridimensional closed system of the present invention, in which one of the walls of the tridimensional enclosure is hypothetically open to illustrate that all the internal surfaces (shaded areas) of the enclosure are mirrors.

### DETAILED DESCRIPTION OF THE INVENTION

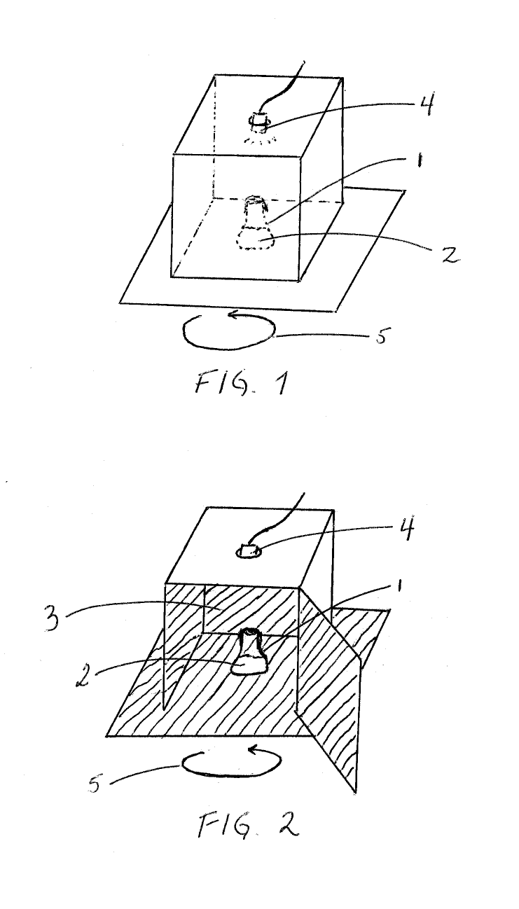

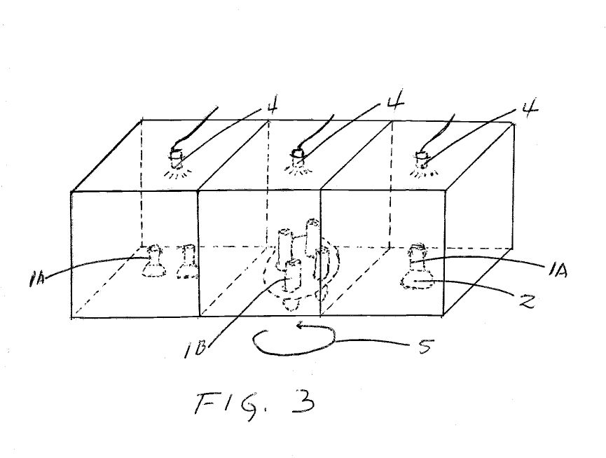

the present invention provides a tridimensional closed system that houses within biological processes, wherein said system comprises a tridimensional enclosure with one (FIGS. 1 and 2) or more compartments (FIG. 3) with internal surfaces, wherein all tridimensional enclosure and internal surfaces have all the characteristics of a mirror (3), and wherein said tridimensional enclosure houses all the elements of a ongoing biological process (1 y 2) affected by lighting; and, at least one source of light (4) that illuminates the tridimensional enclosure internal space, wherein the tridimensional enclosure is sealed in order not to allow entry of light from outside of the tridimensional enclosure.

The definition of the tridimensional enclosure includes all kind of enclosures with room or space in any geometrical shape or form, e.g., incubators, bioreactors, greenhouses, etc., that houses within all the elements of any type of ongoing biological process either directly inside the tridimensional enclosure or in a support or container (1) with inside the enclosure.

In the system of the present invention, if all the elements of the ongoing biological process are in a container (1) inside the tridimensional enclosure, said container can be any geometrical shaped container that holds, e.g., culture media (2), etc., and other elements necessary for the ongoing biological process. Examples of containers commonly used are Erlenmeyer flasks (1A) (FIG. 3), laboratory tubes (1B), etc.

The definition of a biological process affected by lighting covers all kind of light affected biological processes driven by the human hand under controlled conditions: in vitro lab cultures, human cell cultures, animal cell culture, plant cell cultures, microorganism cultures, tissue growth cultures, plant development, plant growth, plant propagation, biomass production (human, animal, plant, fungal, bacterial biomass, etc.), fermentation with microorganisms (e.g., yeast, bacteria, etc), alga growth, alga driven processes (e.g., Co2 detoxification, biodiesel production and refining, materials and substance production, etc), microorganism driven processes (protein, material and substance production, etc), plant driven processes, cell and tissue driven processes, etc

In a preferred embodiment of the system of the present invention, all tridimensional enclosure internal surfaces are mirrors. However, the system of the present invention also covers any kind of surface that has all the characteristics of a mirror although technically such surface may not be a mirror.

The mirror or mirror like surfaces inside the tridimensional enclosure fully reflect the light emitted by the light source, so all the light emitted is retained and evenly distributed inside the tridimensional enclosure with minimal or no loss of light to the outside of the tridimensional enclosure.

In another preferred aspect of the system of the present invention, the source of light is a Light Emitting Diode (LED), wherein the LED emits a specific wavelength light.

The LED definition covers all kind of LEDs that emit a light wavelength in any possible range of the visible and invisible light spectrum. The LED definition covers white light emitting LEDs, ultraviolet light emitting LEDs, violet light emitting LEDs, blue light emitting LEDs, green light emitting LEDs, yellow light emitting LEDs, orange light emitting LEDs, red light emitting LEDs, and infrared light emitting LEDs.

In one more aspect of the system of the present invention, the tridimensional enclosure has a mechanism to regulate temperature. Said mechanism could be any device to generate heat.

In one further aspect of the system of the present invention, the tridimensional enclosure has a mechanism to monitor temperature. Said mechanism includes, thermostats, heat sensors, etc.

In another aspect of the system of the present invention, the tridimensional enclosure has mechanisms to regulate and monitor humidity.

In an additional aspect of the system of the present invention, the system has a mechanism of agitation (5).

In another aspect of the system of the present invention, the tridimensional enclosure is constituted by more than one compartment, wherein all compartments have mirror or mirror like internal surfaces, and wherein each compartment has at least one source of light (4) (FIG. 3) that illuminates inside each compartment.

In a further aspect of the system of the present invention, the tridimensional enclosure is constituted by more than one compartment (FIG. 3), wherein each compartment has at least one source of light (4(FIG. 3) that illuminates inside each compartment, wherein the source of light is a LED, and wherein the source of light of each compartment emits a specific light wavelength, wherein said LED could be a white light emitting LEDs, ultraviolet light emitting LEDs, violet light emitting LEDs, blue light emitting LEDs, green light emitting LEDs, yellow light emitting LEDs, orange light emitting LEDs, red light emitting LEDs, and/or infrared light emitting LEDs.

While the description presents the preferred embodiments of the present invention, additional changes can be made in the form and disposition of the parts without distancing from the basic ideas and principles comprised in the claims.

### EXAMPLE

The retention of light was measured by putting a commercially available luxometer inside a cubical box (55 cm side length). Measurements with the luxometer were made for two settings: i) the cubical box has all six internal surfaces covered with mirrors, and ii) the cubical box has five internal surfaces completely covered with mirrors and the sixth surface (just one surface out of six) is not covered with a mirror but had a very clear whitish gray color. Measurements were performed for three LEDs: blue LED, yellow LED and red LED as it is shown in table 1. The LEDs were commercially available 2.5 Watt lamps (Optiled™ 110V Spotlight LED Light Bulb Next Gen Silicon Valley Light Emitting Diode). Results are shown in Table 1.

TABLE 1

| | BLUE LED | | YELLOW LED | | RED LED | |
|---|---|---|---|---|---|---|
| | 6 mirrors | 5 mirrors | 6 mirrors | 5 mirrors | 6 mirrors | 5 mirrors |
| Time | (luxes) | (luxes) | (luxes) | (luxes) | (luxes) | (luxes) |
| LED off | 14 | 15 | 14 | 14 | 13 | 16 |
| 5 min. on* | 98 | 73 | 85 | 45 | 91 | 57 |
| 10 min. on | 95 | 60 | 62 | 36 | 76 | 49 |
| 20 min. on | 94 | 25 | 54 | 27 | 72 | 35 |
| 30 min. on | 94 | 30 | 48 | 24 | 69 | 25 |
| 60 min. on | 94 | 20 | 48 | 24 | 69 | 24 |
| 90 min. on | 95 | 20 | 45 | 23 | 69 | 24 |

*min on: the time in minutes that the LED has been constantly on.

The results show that when one out of the six internal surfaces of the cubical box is not a mirror (although a surface with very clear whitish gray color), in relation to when the cubical box has all six internal surfaces completely covered with mirrors, there is about 79% light missing for illumination with the blue LED, about 50% light missing for illumination with the yellow LED, and 66% light missing for illumination with the red LED, after 20-90 minutes of constant illumination

In other words, when about 16.6% of the internal surfaces of the tridimensional enclosure (in this case the cubical box), is not a mirror or mirror like surface, there is 50% or more light missing from the illuminated space inside.

It has been shown that because of the system of the present invention, illumination with a LED that generates 2.5 watts, may provide adequate lighting to a 166,375 cm³ (10,648 cubic inches) space for biological processes, and as additionally mentioned in the same inventor referenced patent applications (incorporated herein in their entirety), there is no detectable heat increase.

Therefore, the system of the present invention provides great optimization of illumination with LEDs with potentially great savings of energy used for lighting.

1. A tridimensional closed system to house within biological processes, wherein said system comprises:
A. A tridimensional enclosure with internal surfaces, wherein all tridimensional enclosure internal surfaces have all the characteristics of a mirror, and wherein said tridimensional enclosure houses all the elements of a ongoing biological process affected by lighting;
B. At least one source of light that illuminates the tridimensional enclosure internal space, wherein the tridimensional enclosure is sealed in order not to allow entry of light from outside of the tridimensional enclosure.

2. The tridimensional closed system of claim 1, wherein all tridimensional enclosure internal surfaces are mirrors.

3. The tridimensional closed system of claim 1, wherein the source of light is a Light Emitting Diode (LED), wherein the LED emits a specific wavelength light.

4. The tridimensional closed system of claim 1, wherein the tridimensional enclosure has a mechanism to regulate temperature.

5. The tridimensional closed system of claim 1, wherein the tridimensional enclosure has a mechanism to monitor temperature.

6. The tridimensional closed system of claim 1, wherein the tridimensional enclosure has mechanisms to regulate and monitor humidity.

7. The tridimensional closed system of claim 1, wherein said system has a mechanism of agitation.

8. The tridimensional closed system of claim 1, wherein the tridimensional enclosure is constituted by a single compartment.

9. The tridimensional closed system of claim 1, wherein the tridimensional enclosure is constituted by more than one compartment, and wherein each compartment has at least one source of light that illuminates inside each compartment.

10. The tridimensional closed system of claim 1, wherein the tridimensional enclosure is constituted by more than one compartment, wherein each compartment has at least one source of light that illuminates inside each compartment, wherein the source of light is a LED, and wherein the source of light of each compartment emits a specific light wavelength.
